(19) United States
(12) Patent Application Publication
(10) Pub. No.: US 2024/0367683 A1
(43) Pub. Date: Nov. 7, 2024

(54) CONTROL UNIT AND METHOD FOR OPERATING AN AUTONOMOUS VEHICLE

(71) Applicant: DAIMLER TRUCK AG, Leinfelden-Echterdingen (DE)

(72) Inventor: Fridtjof STEIN, Ostfildern (DE)

(21) Appl. No.: 18/654,266

(22) Filed: May 3, 2024

(30) Foreign Application Priority Data
May 5, 2023 (DE) 10 2023 111 830.7

(51) Int. Cl. B60W 60/00; B60W 30/09; G06V 20/58

(52) U.S. Cl. CPC B60W 60/0016; B60W 30/09; G06V 20/58; B60W 2420/403; B60W 2520/10; B60W 2554/4046

(57) ABSTRACT

A gated camera records images of a roadway in a longitudinal direction in front of a vehicle. An object is recognized in the images and it is determined using an optical flow, considering distinct movement information of the vehicle, whether a braking and/or an evading maneuver is required to avoid a collision with the object. Using the optical flow it is determined whether the object is in contact with the roadway, has a distinct movement, is moved out of a driving corridor of the vehicle or into the driving corridor. When the distinct movement of the object is erratic or the object is moved out of the driving corridor, the object is classified as able to be driven over or otherwise as not able to be driven over. A braking and/or evading maneuver is carried out only with an object that is classified as not able to be driven over.

### CROSS-REFERENCE TO RELATED APPLICATIONS

This application claims priority under 35 U.S.C. § 119 to German patent application 10 2023 111 830.7, filed on May 5, 2023, the entire disclosure of which is herein expressly incorporated by reference.

### BACKGROUND AND SUMMARY OF THE INVENTION

Exemplary embodiments of the invention relate to a method for operating an autonomous vehicle and a control unit for controlling an autonomous vehicle.

In the future, automatically driving cars, for example lorries and passenger cars, will increasingly be in transit on motorways and other roads.

Such vehicles are localized by means of sensors (typically Lidar, camera, radar) and map data in the present infrastructure and adjust their driving behavior to other traffic participants surveyed by the sensors.

These sensors, installed for this purpose, have survey characteristics, which are determined by the sensor type, the structural shape and physical boundary restrictions. Typically, the installed sensors have various tasks. For example, the Lidar surveys a region relevant to the traffic three-dimensionally in front of the vehicle. At the same time, semantics of the scenery that can be seen are determined using the data of a camera and traffic symbols and traffic lights are recognized.

Requirements derived from this determine sensor parameters, such as base width, focal distance, opening angle, pixel density, sensor type (colored or monochrome), etc.

Objects detected using the sensors can be able to be driven over or cannot be able to be driven over. The inability to drive over a potentially dangerous object detected by the sensors has been defined, up to now, by its position (in the driving corridor of the vehicle), its size, and expansion. The ability to drive over the object depends here at least on its mass. An object classified as not being able to be driven over potentially triggers an unwanted maneuver, for example an evading maneuver or full braking. While a cardboard box, for example, can be driven over, this is not possible in the event of a concrete block of the same size. In order to predict the ability to be driven over, it is thus desirable to know the masses of objects in the driving corridor.

DE 10 2020 208 068 A1 describes a method for recognizing an object appearing in a monitoring region, wherein a first image and a second image of the monitoring region are captured for stereo image processing, wherein, based on the first image and the second image, a disparity map of the monitoring region is ascertained, wherein, based on the disparity map, a monitoring region free space is determined, wherein the monitoring region free space is segmented into at least one stixel region, wherein a further first and/or further second image of the monitoring region is captured, wherein, based on the first image and the further first image and/or the second image and the further second image, an optical flow of the monitoring region is ascertained, wherein, based on the ascertained optical flow, a flow map with at least one object flow region is determined, wherein, based on a comparison of the object flow region with the at least one stixel region, an object appearing in the monitoring region is determined.

Exemplary embodiments of the invention are directed to a novel method for operating an autonomous vehicle and a novel control unit for controlling an autonomous vehicle.

In a method for operating an autonomous vehicle, images of a roadway in a longitudinal direction in front of the vehicle are recorded by means of a camera, wherein at least one object is recognized in the images, wherein it is determined by means of an optical flow taking into consideration self-motion information of the vehicle as to whether a braking and/or an evading maneuver is required to avoid a collision with the object. According to the invention, it is determined by means of the optical flow as to whether the object is in contact with the roadway, has self-motion, moves out of a driving corridor of the vehicle or into the driving corridor, wherein, when the self-motion of the object is erratic or the object is moved out of the driving corridor, the object is classified as able to be driven over and otherwise as unable to be driven over, wherein only with an object classified as unable to be driven over is a braking and/or evading maneuver carried out, wherein a gated camera is used as the camera.

The present invention can be used, for example, with a utility vehicle. However, use in a bus or a passenger car is also possible.

Exemplary embodiments of the invention are described in more detail below by means of the drawings.

### BRIEF DESCRIPTION OF THE DRAWING FIGURES

### Shown are:

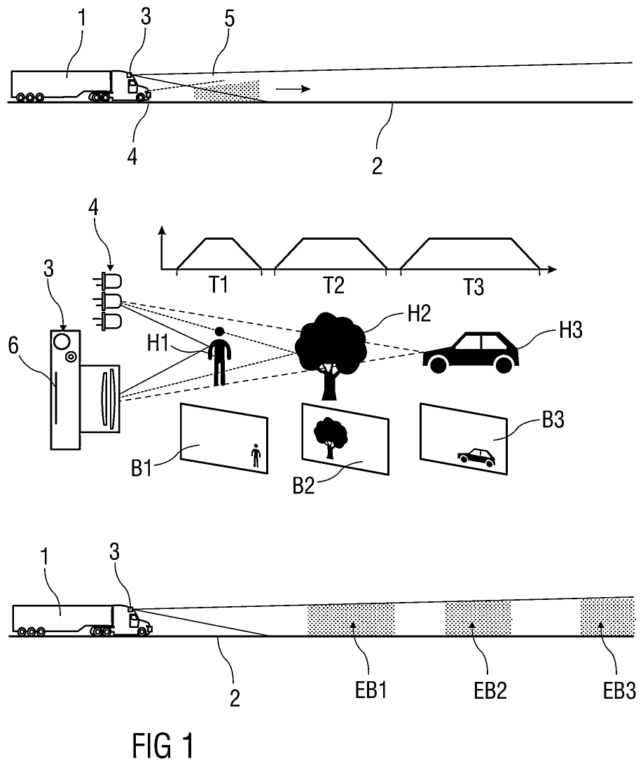

FIG. 1 a schematic view of a vehicle with a gated camera and a light source,

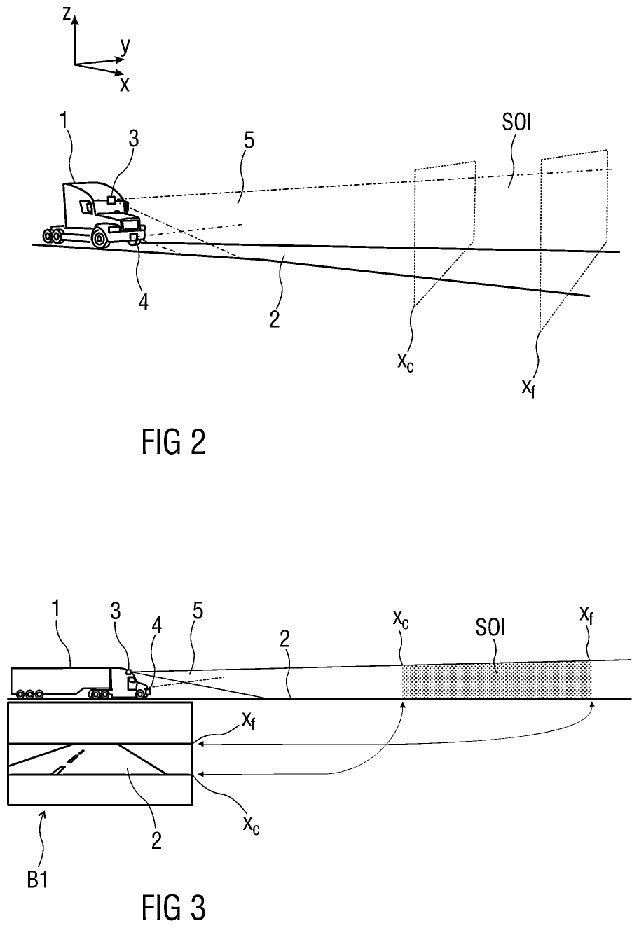

FIG. 2 a schematic view of the vehicle with the gated camera, the light source and a slice of interest,

FIG. 3 a schematic view of the vehicle with the gated camera, the light source and the slice of interest with an empty roadway lying ahead in the longitudinal direction,

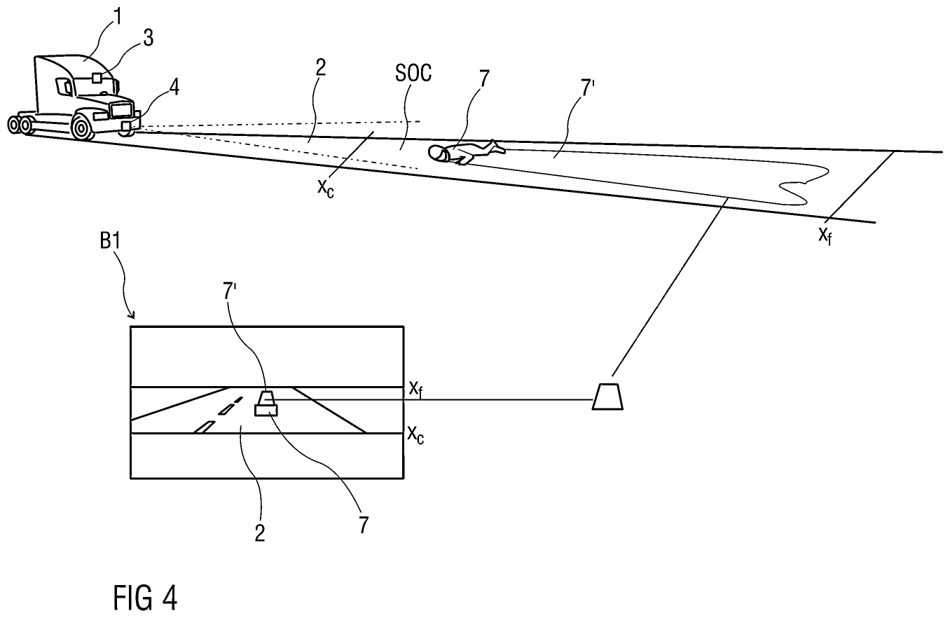

FIG. 4 a schematic view of the vehicle with the gated camera, the light source and the slice of interest with a roadway lying ahead in the longitudinal direction on which an object lies,

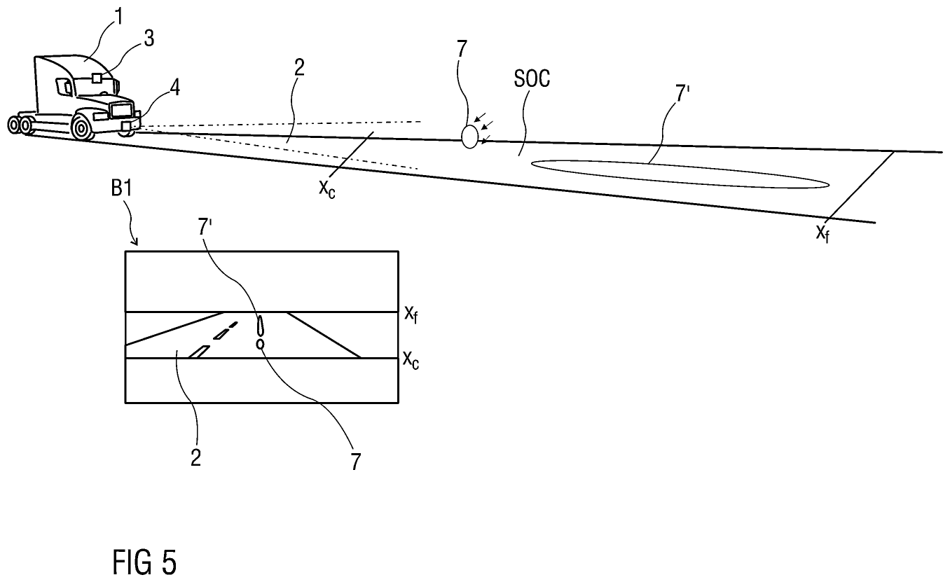

FIG. 5 a schematic view of the vehicle with the gated camera, the light source and the slice of interest with a roadway lying ahead in the longitudinal direction, above which an object is hovering,

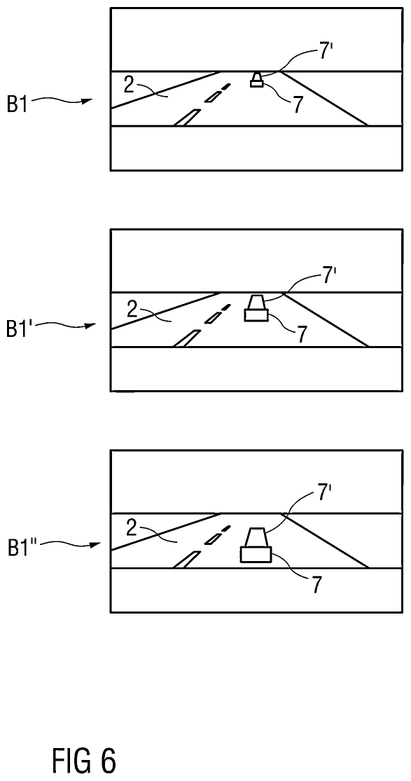

FIG. 6 a schematic view of three images captured one after the other with a stationary object and its shadow in the slice of interest,

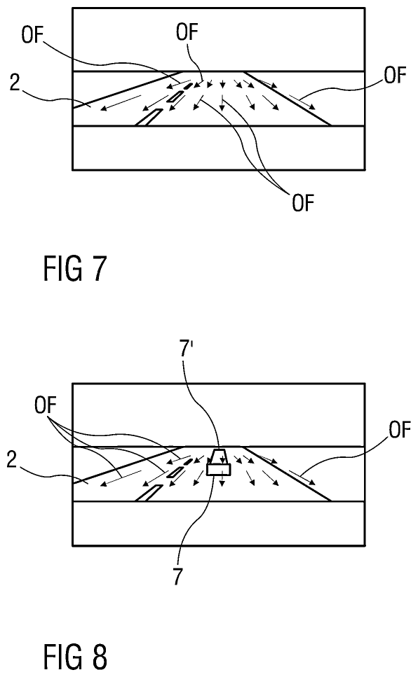

FIG. 7 a schematic view of an optical flow of the roadway into the images from FIG. 6 without considering the object,

FIG. 8 a schematic view of the optical flow of the roadway, the object and its shadow in the images from FIG. 6,

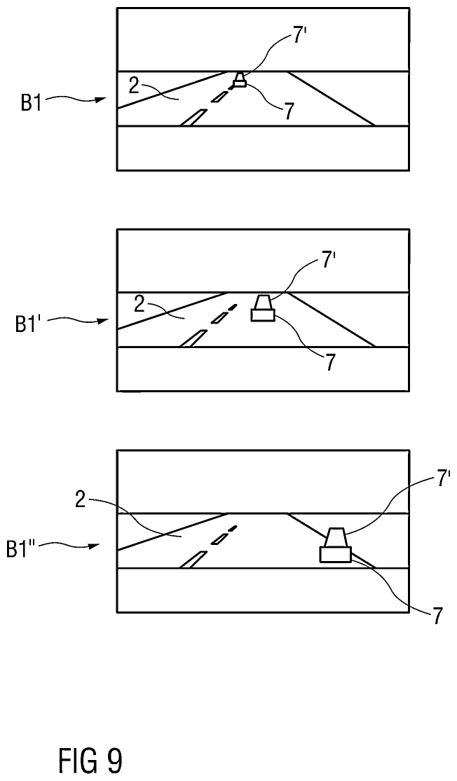

FIG. 9 a schematic view of three images captured one after the other with an object moving on the roadway and its shadow in the slice of interest,

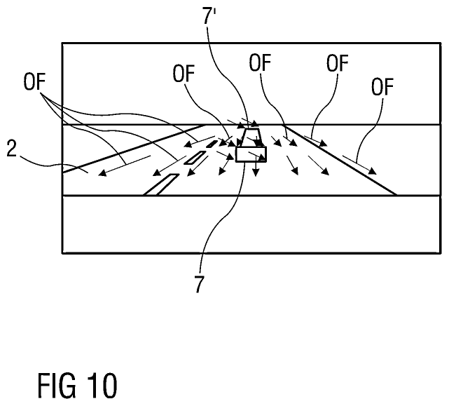

FIG. 10 a schematic view of the optical flow of the roadway, the object and its shadows in the images of FIG. 9,

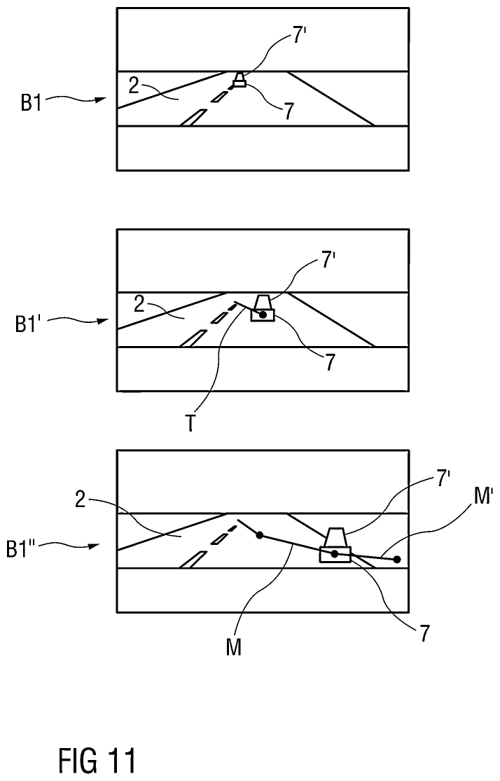

FIG. 11 a schematic view of three images captured one after the other with an object moving on the roadway and its shadow in the slice of interest, and

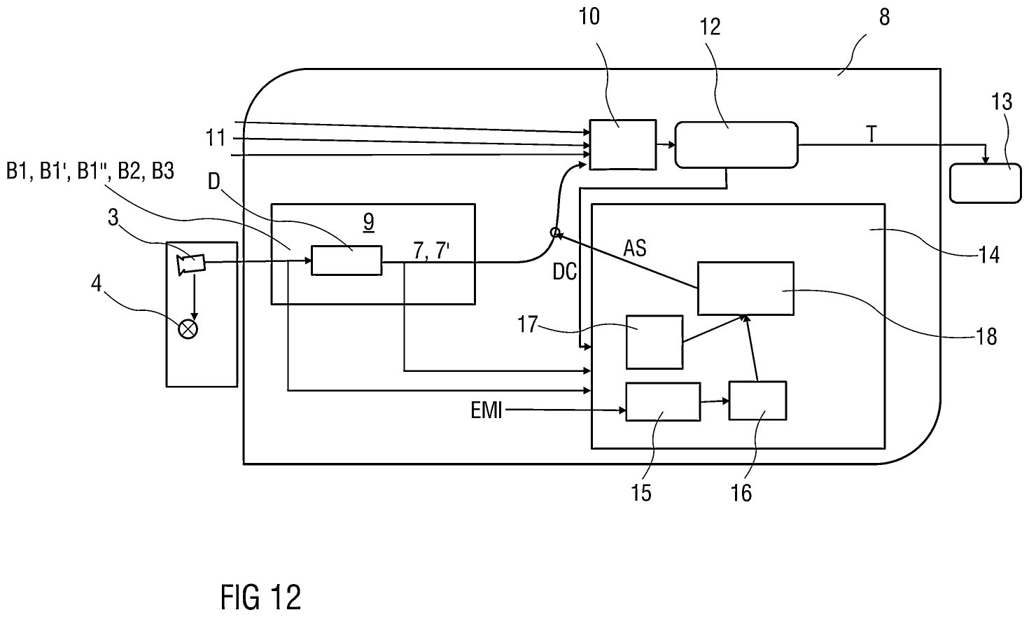

FIG. 12 a schematic view of a control unit of the vehicle for carrying out a method for controlling the vehicle.

Parts corresponding to one another are provided with the same reference numerals in all figures.

### DETAILED DESCRIPTION

FIG. 1 is a schematic view of a vehicle 1, in particular a utility vehicle, on a roadway 2. The vehicle 1 can be formed as a partially autonomous or fully autonomous vehicle 1. The vehicle 1 has at least one gated camera 3, the sight volume 5 (frustum) of which can be aligned in a longitudinal direction x, i.e., forwards, and at least one light source 4, for example a laser light source, for pulse-like illumination of the roadway 2. Here, the light source 4 is arranged spatially offset in relation to the gated camera 3, for example offset in a vertical direction z and/or in a transverse direction y.

The gated camera 3 (for example produced by the company Brightway Vision) combines the light duration of the emitted light with narrow closure times of a pixel gate array of an image sensor 6 formed as a CMOS image sensor, which is time-synchronized with the light source 4, and in this way generates images B1, B2, B3 which are referred to as “gates”. “Gates” are images B1, B2, B3, which constitute only the light that has travelled the stretch between the light source 4 and the image sensor 6 within a predetermined time interval T1, T2, T3 (closure time of the image sensor 6), and thus determined removal regions EB1, EB2, EB3. By a delay between illumination and image capturing being set, the surroundings can be divided into individual images B1, B2, B3, which depict only a certain removal region EB1, EB2, EB3. The gated camera 3 has advantages with atmospheric disturbances, since it implicitly disregards reflections outside the gates (backscatter avoidance).

With its global shutter technology and the illumination by VSCEL light impulses, the gated camera 3 captures 90 images per second, for example.

This high frequency enables a new surveying approach. The terms gate and slice are used synonymously here.

Gated cameras 3 can be used to recognize obstacles H1, H2, H3 on a roadway 2. Thus, an important contribution for safely operating autonomous vehicles 1 is achieved. For this, the light sources 4 used are separated and offset spatially from the image sensor 6, whereby this results in a shading of the region behind an obstacle H1, H2, H3 on the roadway 2, which appears clearly larger in the image B1, B2, B3 than the actual object or obstacle H1, H2, H3 is depicted in the image B1, B2, B3. This effect and the shadow shape through several light sources 4 clearly facilitate the recognition of obstacles H1, H2, H3 in the image B1, B2, B3.

The present invention concentrates only on one image B1, B2, B3, for example B1, instead of a plurality of images B1, B2, B3. A removal region belonging to this one image B1 in front of the vehicle 1 is referred to below as a slice of interest SOI.

FIG. 2 is a schematic view of the vehicle 1 with the gated camera 3, the light source 4, and the slice of interest SOI, which lies between a limit lying closer to the vehicle 1 with a first removal x_{c} and a limit further removed from the vehicle 1 with a second removal x_{f}. The limits correspond to the intersection of the sight volume 5 (frustum) with the vertical boundary faces of the slice of interest SOI, in each case with the removals x_{c} and x_{f}.

FIG. 3 is a schematic view of the vehicle 1 with the gated camera 3, the light source 4, and the slice of interest SOI with an empty roadway 2 lying ahead in the longitudinal direction x, which is depicted in image B1. For the gated camera 3, objects within the slice of interest SOI belonging to image B1 are visible in image B1, while objects outside the slice of interest SOI are not visible in this image B1 for the gated camera 3.

When an object is observed over a certain period of time, then a mass of the object can be roughly predicted when the object moves. With erratic movements of the object, a human driver presumes the influence of airflows such as wind or turbulence of other traffic participants. For example, a collision with very light objects, for example bin bags flying around, is not critical and does not have to be avoided by emergency braking. In addition, with a continuous movement, it can be predicted whether the moved object moves in or out of the distinct driving corridor.

Exemplary embodiments of the present invention classifies detected objects based on their distinct movement and ground contact with regards to their significance relevant to special maneuvers such as emergency braking and evading movements. Here, by ascertaining an optical flow, it is established as to whether the object
is lying fixedly on the road in its own driving corridor (for example a lost tire, a crashed motorbike driver, lost load),
is carrying out erratic movements (such as tumbleweed or a bin bag). Optionally, such a light object loses contact with the ground, which can be detected by the throw of a shadow.
is moving out of the distinct driving corridor (for example an animal),
is moving into the distinct driving corridor (for example an animal).

FIG. 4 is a schematic view of the vehicle 1 with the gated camera 3, the light source 4 and the slice of interest SOI with a roadway 2 lying ahead in the longitudinal direction, on which an object 7, for example a crashed motorbike driver, is lying, which throws a shadow 7′. The slice of interest SOI with the section of the roadway 2, the object 7 and its shadow 7′ are depicted in the image 1.

FIG. 5 is a schematic view of the vehicle 1 with the gated camera 3, the light source 4 and the slice of interest SOI with a roadway 2 lying ahead in the longitudinal direction x, above which an object 7, for example a bin bag, is hovering, which throws a shadow 7′. The slice of interest SOI with the section of the roadway 2, the object 7 and its shadow 7′ are depicted in image 1.

FIG. 6 is a schematic view of three images B1, B1′, B1″ captured one after the other with a stationary object 7 and its shadow 7′ in the slice of interest SOI on the roadway 2. FIG. 7 is a schematic view of the optical flow OF of the roadway 2 in the images B1, B1′, B1″ without the object 7, based on a distinct movement of the vehicle 1. FIG. 8 is a schematic view of the optical flow OF of the roadway 2, the object 7 and its shadow 7′ in the images B1, B1′, B1″ based on a distinct movement of the vehicle 1. The optical flow OF thus has only minimal or no deviations from the expected behavior depicted in FIG. 7.

FIG. 9 is a schematic view of three images B1, B1′, B1″ captured one after the other with an object 7 moving on the roadway 2 and its shadow 7′ in the slice of interest SOI. FIG. 10 is a schematic view of the optical flow OF of the roadway 2, of the object 7 and of its shadow 7′ in the images B1, B1′, B1″ based on a distinct movement of the vehicle 1. The optical flow OF has clear deviations from the expected behavior depicted in FIG. 7 as a result of the movement of the object 7 and its shadow 7′.

FIG. 11 is a schematic view of three images B1, B1′, B1″ captured one after the other with an object 7 moving on the roadway 2 and its shadow 7′ in the slice of interest SOI. A movement M of the object 7 is traced across the series of images B1, B1′, B1″ and a future movement M′ is predicted from the recorded movement M.

FIG. 12 is a schematic view of a control unit 8 of the vehicle 1 for carrying out a method for controlling the vehicle 1. The control unit 8 has an object recognition unit 9 for detecting D objects 7 in images B1, B1′, B1″, B2, B3 of the gated camera 3 synchronized with the light source 4. The recognized objects 7 are supplied to a fusion module 10, which carries out a sensor fusion with data of further sensors 11. As further sensors 11, at least one lidar sensor, at least one radar sensor, and/or at least one camera can be provided. The fused data is supplied to a behavior planning module 12, which determines a trajectory T for the vehicle 1, which is converted by means of an actuator system 13 with regards to longitudinal regulation and transverse regulation. The trajectory T can be chosen in such a way that the vehicle 1 avoids a collision with recognized objects 7 by braking or evading.

In addition, a detection module 14 is provided to which the images B1, B1′, B1″, B2, B3 of the gated camera 3, data relating to the recognized objects 7, and, optionally, relating to its shadow 7′, distinct movement information EMI of the vehicle 1, for example a longitudinal speed, a yaw speed, and/or a pitching speed, and a driving corridor DC provided by the behavior planning module 12 are supplied. The detection module 14 has a movement analysis module 15 for detecting a movement M of the objects 7. Furthermore, a tracking analysis module 16 can be provided for monitoring the movement M and/or for predicting the future movement M′ of the objects 7. Furthermore, a ground contact analysis module 17 can be provided, which establishes, for example by means of the shadow 7′, as to whether a recognized object 7 is in contact with the roadway 2.

Furthermore, a classification module 18 can be provided, which ascertains, i.e., classifies, by means of the data provided by the movement analysis module 15, by the tracking analysis module 16 and by the ground contact analysis module 17, whether or not the relevant object 7 is so lightweight that it can be driven over. This classification is supplied to the fusion module 10, for example as a significant attribute AS of the recognized object 7, such that the behavior planning module 12 can change the trajectory T when the object 7 has been classified as not able to be driven over, or the trajectory T can be maintained, when the object 7 has been classified as being able to be driven over.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

1 Vehicle
2 Carriageway
3 Gated camera
4 Light source
5 Sight volume
6 Image sensor
7 Object
7′ Shadow
8 Control unit
9 Object recognition unit
10 Fusion module
11 Further modules
12 Behavior planning module
13 Actuator system
14 Detection module
15 Movement analysis module
16 Tracking analysis module
17 Ground contact analysis module
18 Classification module
AS Significant attribute
B1, B1′, B1″, B2, B3 Image
D Detection
DC Driving corridor
EB1, EB2, EB3 Removal region
EMI Distinct movement information
H1, H2, H3 Obstacle
M Movement
M′ Future movement
OF Optical flow
SOI Slice of interest
T Trajectory
T1, T2, T3 Time interval
x Longitudinal direction
x_{c} First removal
x_{f} Second removal
y Transverse direction
z Vertical direction

What is claimed is:

1. A method for operating an autonomous vehicle, the method comprising:
recording, by a gated camera of the autonomous vehicle, images of a roadway in a longitudinal direction in front of the vehicle;
recognizing, by the autonomous vehicle, at least one object in the recorded images;
determining, using an optical flow that considers distinct movement information of the autonomous vehicle, whether a braking maneuver or an evading maneuver is required to avoid a collision with the at least one object,
wherein it is determined using the optical flow whether the at least one object is in contact with the roadway, has a distinct movement, is moved out of a driving corridor of the autonomous vehicle, or is moved into the driving corridor of the autonomous vehicle,
wherein, when the distinct movement of the at least one object is erratic or the at least one object is moved out of the driving corridor, the at least one object is classified as able to be driven over,
wherein, when the distinct movement of the at least one object is not erratic or the at least one object is not moved out of the driving corridor, the at least one object is classified as not able to be driven over and the autonomous vehicle performs the braking maneuver or the evading maneuver.

2. The method of claim 1, further comprising:
determining the optical flow considering a shadow of the at least one object.

3. The method of claim 1, a significance attribute is allocated to the at least one object by the classification of the at least one object.

4. The method of claim 1, wherein the distinct movement information of the autonomous vehicle comprises a longitudinal speed, a yaw speed, or a pitching speed.

5. A control unit configured to control an autonomous vehicle, wherein the control unit is configured to
record, by a gated camera of the autonomous vehicle, images of a roadway in a longitudinal direction in front of the vehicle;
recognize, by the autonomous vehicle, at least one object in the recorded images;
determine, using an optical flow that considers distinct movement information of the autonomous vehicle, whether a braking maneuver or an evading maneuver is required to avoid a collision with the at least one object,
wherein it is determined using the optical flow whether the at least one object is in contact with the roadway, has a distinct movement, is moved out of a driving corridor of the autonomous vehicle, or is moved into the driving corridor of the autonomous vehicle,
wherein, when the distinct movement of the at least one object is erratic or the at least one object is moved out of the driving corridor, the at least one object is classified as able to be driven over,
wherein, when the distinct movement of the at least one object is not erratic or the at least one object is not moved out of the driving corridor, the at least one object is classified as not able to be driven over and the autonomous vehicle performs the braking maneuver or the evading maneuver.
